(19) United States
(12) Patent Application Publication
(10) Pub. No.: US 2006/0289578 A1
(43) Pub. Date: Dec. 28, 2006

(54) Vehicle door transport device, method and product thereof

(76) Inventor: Ron Beyes, Franktown, CO (US)

Correspondence Address: WYATT BARTON PRATT, 15 COLUMBIA AVENUE, HOPEWELL, NJ, 08525, US

(21) Appl. No.: 11/168,964

(22) Filed: Jun. 28, 2005

(51) Int. Cl. B60R 11/00

(52) U.S. Cl. 224/488

(57) ABSTRACT

A vehicle door transport device for transporting removable vehicle doors has door hinge transport receivers and door transport striker plates that are positionally fixed to receive and support one or more detached vehicle doors. The present invention is particularly applicable for transporting detached vehicle doors such as from Jeep® or Hummer® vehicles.

### BACKGROUND OF THE INVENTION

1. Field of the Invention

The present invention provides an automotive accessory directed to the transport of detachable automotive doors.

2. Brief Description of the Related Art

Detachable doors from Jeeps® or Hummer® vehicles are attached to the respective vehicles with a hinge system. Generally, the door has a component pin device that is inserted into a receiver cylinder external of the vehicle door frame. Once the pin or pins are inserted into the receiver cylinder, the door may be closed with a door latch that couples to a door striker plate on the vehicle. Doors are removed by disengaging the door latch from the door striker plate and lifting the vehicle door pin(s) off the receiver cylinder. The doors are typically left in a garage, such as using the automotive door storage apparatus disclosed in U.S. Pat. No. 6,811,038 to Sanderson.

Mounting detached vehicle doors on a vehicle has been disclosed in U.S. Pat. No. 3,268,131 to Benton. In Benton, detached vehicle doors are mounted horizontally on the hood of a Jeep-type vehicle using left and right support members to support socket portions that receive the door hinge pins. The door is further mounted using a hook to fasten an elastic cord on one end to the door handles.

As several types of vehicles are designed to have removable doors, there is a need in the industry to remove the doors and carry these doors with the vehicle for inclement weather or security reasons, e.g., not leave the doors at home. As such, these doors need to be removed, stored and/or reinstalled at convenient times and locations for the occupants of the vehicle. Because of the size and weight of these doors, it is generally impractical to carry the detached doors, such as full and half-size detachable vehicle doors, inside the vehicle. According, there is a need in the art to provide a reliable mechanism for securely and safely transporting these vehicle doors while the doors are detached from the vehicle door frames. The present invention addresses this and other needs.

### SUMMARY OF THE INVENTION

The present invention includes a vehicle door transport device for transporting removable vehicle doors having one or more vehicle mountable door hinge transport receivers, one or more vehicle securable door striker plates and a positional support effective to fix the location of the door hinge and striker plates effective to receive and support one or more vehicle doors. The present invention is particularly applicable for transporting detached vehicle doors from Jeep® or Hummer® vehicles.

The present invention also includes a method for transporting one or more vehicle doors comprising the steps of providing the above-described vehicle door transport device on a vehicle, mounting one or more vehicle doors into the vehicle door transport device by placing at least one door hinge into at least one door hinge transport receivers, securing the door latch of the mounted vehicle door into the striker plate and driving the vehicle. A transported vehicle door by this method has a reduced chance of being damaged during mounting and transport.

### BRIEF DESCRIPTION OF THE DRAWINGS

FIG. 1 illustrates a side view of a rear mounted vehicle door transport device of the present invention holding one detached vehicle door;

FIG. 2 illustrates a side view of a side mounted vehicle door transport device holding a single door;

FIG. 3 illustrates a top view of a rear mounted vehicle door transport device of the present invention holding a single detached vehicle door with a location for other detached vehicle doors not being used; and,

FIG. 4 illustrates a top view of a rear mounted vehicle door transport device of the present invention showing the removable/insertion of a detached vehicle door into the vehicle door transport device of the present invention.

### DETAILED DESCRIPTION OF THE PREFERRED EMBODIMENT

The present invention provides a vehicle door transport device for transporting removable vehicle doors, and method for transporting detachable vehicle doors using this device, while the doors are detached from door frames of the vehicle. The present invention is applicable to detachable vehicle doors having a latch mechanism for securing the door while it functions to hold or lock a vehicle during use as a door into the vehicle. Although Jeep® and Hummer® are generally referenced herein as particularly applicable vehicles for use of the present invention, other types of detachable vehicle doors are also applicable for use of the present invention.

The present invention provides the ability for the existing hinge pins of a detached vehicle door to support the front edge of that door in a vertical position during transport, while having the striker latch of the door support the aft edge of the transported door. This provides an even distribution of the weight of the vehicle, door while positioned within the vehicle door transport device in a manner that the doors are designed to be used while in motion, e.g., the doors being evenly supported by the door striker latch and hinge pins. Using the vehicle door transport device of the present invention, a transported vehicle door is substantially protected from transport damage.

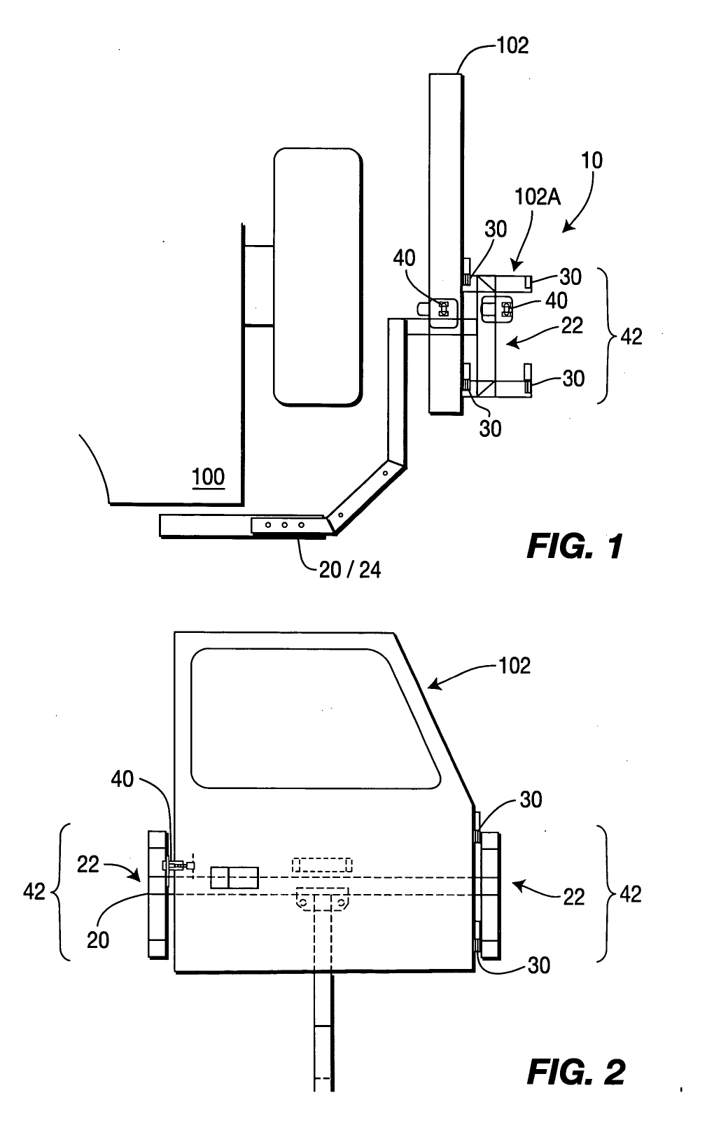

As seen in FIG. 1, illustrating a side view of a rear mounted vehicle door transport device 10 of the present invention, the vehicle door transport device 10 includes a vehicle brace 20 that connects to a positional support 22. The positional support 22 has a door hinge transport receiver 30 and transport striker plate 40, collectively referred to as transport receiver 42, for receiving the detached vehicle door 102, described below. The brace 20 may include any appropriate attaching and securing means for supporting the vehicle door transport device 10 onto a vehicle, such as a bracket, securable receiver, or other mechanical device capable of maintaining the weight of the vehicle door transport device 10 during movement of the vehicle. In one particularly preferred embodiment, the positional support 22 of the vehicle door transport device 10 includes a positional support 22 having a bracket 20 attachable to the vehicle. The bracket 24 may include any appropriate attaching device, such as being bolt mounted, slide mounted, snap mounted, twist mounted, etc., and combinations thereof. This bracket 24 of the positional support 22 may attach to the bumper, vehicle body or accessories of the vehicle, such as attaching to a vehicle receiver hitch or spare tire mount. In one preferred embodiment, the positional support 22 includes a structural component of a vehicle, i.e., the door hinge receiver 30 and transport striker plate 40 are mounted directly to a component part of the vehicle, such as to paneling on the sides or back of the vehicle, a bumper system, and the like. In such a configuration, a brace 20 is unnecessary for supporting the positional support 22. Generally the transported vehicle doors 102 originate from the transporting vehicle 100.

As further seen in FIG. 1, the rear mounted vehicle door transport device 10 is shown holding one detached vehicle door 102 from the vehicle, although the positional support 22 may hold any appropriate number of doors, such as one, two, three, four, or more, detached vehicle doors, when applicable. Also shown is an empty position 102A for a second detached vehicle door 102 within the positional support 22. Supported vehicle doors 102 within the vehicle door transport device 10 are appropriately positioned to minimize and/or negate any damage during travel, such as in a layered configuration, shown in FIG. 1, layered out from the surface of the vehicle, side-by-side with each door next to, and not touching, the surface of the vehicle 100, etc. The mounted vehicle door transport device 10 may be mounted to the vehicle 100 at various locations on the vehicle 100, such as the vehicle's top, side, back, front and combinations thereof. Preferably, mounting of the vehicle door transport device 10 is on the back or rear side of the vehicle 100.

The present invention may be constructed using any appropriate resilient material to support and retain the vehicle door 102 in place while engaging the door pins (also referred to as door hinge) and door latch of the detached vehicle door 102, including such materials as, without limitation, steel tubing and steel plate. Construction may include the steel material being sawed or bent to size, and assembled by welding together individual components of steel, which may be painted or otherwise conditioned to withstand wear. Attached to, and part of, the vehicle door transport device 10, the door hinge transport receiver 30, such as in the configuration of hinge receiver cylinders, and transport striker plate 40 are positioned to hold the detached vehicle door 102 on the vehicle door transport device 10. The transport striker plate 40 is preferably adjustable to securely hold the door latch of the detached vehicle door 102 in place on the vehicle door transport device 10. The adjustable transport striker plate 40 may be adjusted along the three axis of motion, sideways, up-down, and in-out. This allows the transport receiver 42 to securely hold the vehicle doors 102 and prevent vibration. The transport striker plate 40 of the vehicle door transport device 10 may include an appropriate assembly to accommodate the door latch mechanism, such as either a U shape or straight latch mechanism, of the detached vehicle door 102 of a specific vehicle 100, e.g., the mechanism on the detached vehicle door 102 that is generally dependent on the particular vehicle 100 supporting the vehicle door transport device 10 of the present invention such as the model of Jeep® or Hummer®. In one preferred embodiment, the vehicle door transport device 10 also includes a bump stop adjacent to the transport striker plate 40. The bump stop includes any appropriate padding that prevents the detached door within the vehicle door transport device 10 from vibrating in-out.

Referring to FIG. 2, the positional support 22 holds one or more vehicle mountable door hinge transport receivers 30 at one end and one or more vehicle securable door transport striker plates 40 at the other end of the vertical support platform 22. As seen in the illustration of FIG. 2, the supported single detached door 102 is supported at two door hinge transport receivers 30 and one door transport striker plate 40. Although the position of the door hinge transport receivers 30 and door striker plates 40 are fixed by the size and configuration of the detached vehicle door 102, generally, the number of door hinge transport receivers 30 and door striker plates 40 are determined by the ability to secure the detached door 102 for transport. As such, a detached vehicle door 102 with two or more door hinge pins may be transported using the same number or less door hinge transport receivers 30. For example, a detached door 102 with three door pins may be transported with two door hinge transport receivers 30 provided that the door hinge transport receivers 30 aligned with two of the three door pins. Generally, multiple door striker plates are not used on detachable vehicle doors, but if used, the minimum number of door striker plates 40 is one, with additional door striker plates 40 possible, with the proper number of door hinge transport receivers 30 and door striker plates 40 determinable by one skilled in the art of detachable vehicle door transport in light of the disclosure herein, particularly for the safe and secure transport of the vehicle doors 102.

As seen in FIG. 2, the positional support 22 fixes the location of the door hinge receivers 30 and transport striker plate 40 relative to each other to receive and support one or more detached vehicle doors 102. This fixed position is determined by the size and configuration of the detached vehicle door 102. In one embodiment of the present invention, the positional support 22 may be adjusted for different vehicle doors 102, such as front doors and rear doors, with a mechanism for changing the relative position of the door hinge receivers 30 and transport striker plate 40, i.e., the location of one or both of the door hinge receivers 30 and striker plates 40 are adjustable to each other. Representative adjusting mechanisms may include a telescoping crossbar, joint devices within the positional support 22, and the like. Such adjusting mechanisms may include a locking or clamping device for maintaining the adjusting mechanisms in a position, or the adjusting mechanism may be maintained at a certain position with the detached vehicle door 102, once inserted.

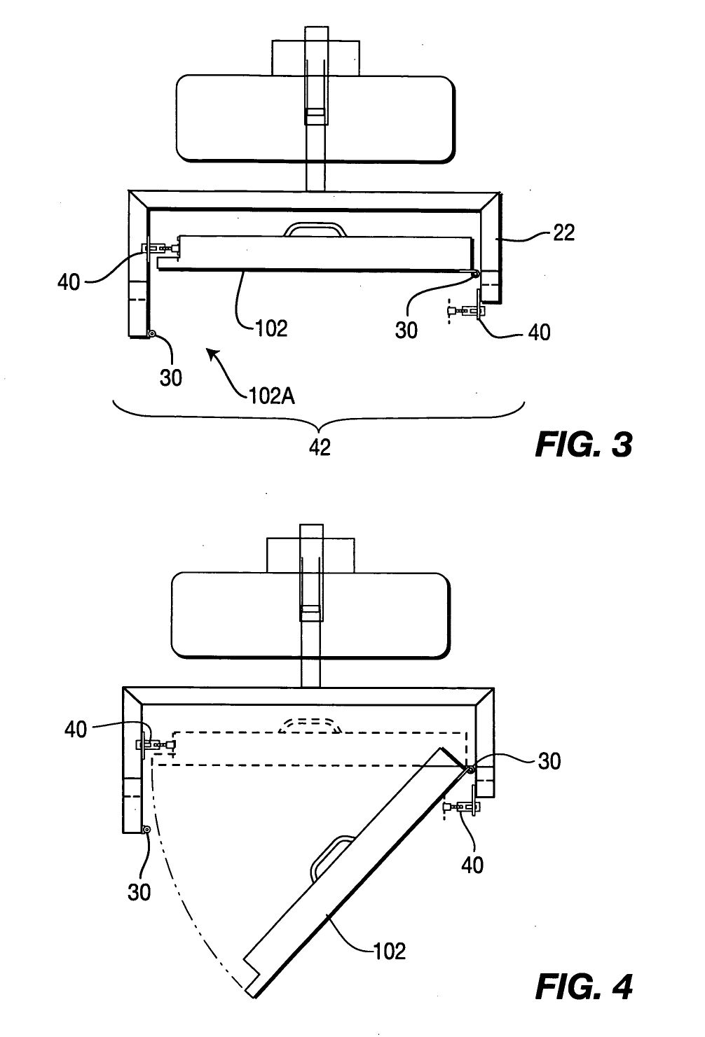

Referring to FIG. 3, a rear mounted vehicle door transport device 10 of the present invention is shown holding a single detached vehicle door 102, with a location 102A for a second detached vehicle door 102 not being used. In FIG. 3, the door 102 is shown as secured on an inner mounting position, with the outer mounting position applicable for receiving a detached door 102 in a flipped position from the first secured detached vehicle door 102. As such, detached vehicle doors 102 coming from the same side of the vehicle 100, e.g., a front door and rear door, would be placed to have the same side of the door adjacent to the other door, i.e., outer door side to outer door side, or inner door side to inner door side. With the doors 102 from opposite sides of the vehicle 100, the detached vehicle doors 102 would be configured as outer door side to inner door side. With the vehicle doors 102 in place within the vehicle door transport device 10, the mounted detached vehicle doors 102 may be covered for further protection during transport, such as a tarp, vinyl cover or other like covering device known in the art for obscuring and protecting articles.

In FIG. 4, the insertion or removal of a detached vehicle door 102 to/from the vehicle door transport device 10 is shown. The insertion of the door 102 generally includes positioning the pins of the vehicle door 102 over the door hinge transport receiver 30, with the door 102 not aligned over the transport striker plate 40. The vehicle door 102 is then lowered with the door pins being inserted into the door hinge transport receivers 30. Once the vehicle door 102 has been lowered, and the door pins are in place, the vehicle door 102 is swung onto the transport striker plate 40 and secured in place. Additionally, the vehicle door 102 may be lowered with the vehicle door 102 aligned having the door latch over the door transport striker plate 40 provided the door latch is maintained “open”, e.g., the door handle remains pulled while the vehicle door 102 is lowered. Problematic with the accessories on vehicles 100, items may be stolen while the vehicle 100 is stopped and unoccupied. With the door 102 in place within the vehicle door transport device 10, a locking mechanism may be used to secure the vehicle door 102 from theft, or the vehicle door 102 may be locked through the door latch, i.e., the same locking mechanism as the door 102 uses to be locked with attached in the doorway of the vehicle 100. Removal of the door 102 from the vehicle door transport device 10 generally includes unlocking the door 102, disengaging the door latch from the transport striker plate 40, and lifting the door 102 (and door pins from the door hinge transport receiver 30). In the vehicle door transport device 10 configuration shown in FIG. 4, the outer vehicle door 102 (not shown in FIG. 4) would be removed prior to the inner vehicle door 102 (shown in FIG. 4), such as swinging the vehicle door 102 out from the transport striker plate 40 (as shown).

The vehicle door transport device 10 of the present invention preferably uses a three point attachment system to secure the detached vehicle doors 102 within the vehicle door transport device 10. In a preferred embodiment, the vehicle door transport device 10 uses two steel receiver cylinders welded within the vehicle door transport and a steel striker plate. In use, the two hinge pins on the detached vehicle door 102 slide into the receiver cylinders. The door latch on the vehicle door 102 attaches to the transport striker plate 40 opposite the receiver cylinder giving the third attachment of the three point attachment system. In this configuration, the vehicle door 102 is balanced within and on the vehicle door transport device 10. Additionally, the detached vehicle doors 102 are held within the vehicle door transport device 10 with an even and proper weight distribution for the particular detached vehicle doors 102 being held. As such, the method of door attachment afforded by the vehicle door transport device 10 protects the detached vehicle doors 102 within the vehicle door transport device 10 by keeping the vehicle doors 102 from rubbing together under normal (routine) or abnormal (extreme) driving conditions. Additionally, the door attachment prevents torque or shear forces from being imparted onto the door pins of the detached vehicle doors 102 held within the vehicle door transport device 10 by supporting the detached vehicle doors 102 in a manner that the vehicle doors 102 were designed to be supported during transit, e.g., the door pins are not subjected to vertical shear forces that impart the weight of the detached vehicle door because with the door latch is engaged with the transport striker plate 40 that blocks movement of the detached vehicle door to shear the door pin(s). This provides a stable transported vehicle door while it is mounted within the vehicle door transport device 10.

In operation of transporting the detached vehicle doors 102, the vehicle doors 102 of a vehicle 100 may be removed from the door frames of the vehicle 100, and inserted into the vehicle door transport device 10. With multiple vehicle doors 102, the vehicle doors 102 are individually inserted into separate sections of the vehicle door transport device 10, by placing at least one door hinge of each vehicle door 102 into at least one door hinge transport receiver 30 of the vehicle door transport device 10, and securing the door latch of the mounted vehicle door 102 into the transport striker plate 40 of the vehicle door transport device 10. With the vehicle door 102 mounted within the vehicle door transport device 10, the vehicle 100 is driven to a particular destination, e.g., beach, restaurant, store, etc. Once the vehicle 100 has been driven to the destination, the driver (and passengers) may disembark from the vehicle 100, disengage the door latch from the transport striker plate 40, lift the vehicle door pin from the door hinge transport receiver 30, and place the vehicle doors 102 back into the vehicle 100 doorframes to lock and secure the vehicle 100 while it is unoccupied.

### EXAMPLE 1

### Construction of Detachable Vehicle Door Transport Device

A detachable vehicle door transport device is constructed having a steel center bar approximately 3 feet long, sloping 90 degrees, with one end attachable to the undercarriage of a vehicle and the other end extending vertically in the air behind the vehicle. The steel center bar extends approximately 1.5 feet horizontally and away from the bottom of the vehicle, and upward behind the vehicle approximately 2 feet. At the top end of the steel center bar, a crossbar is centered and perpendicularly fixed, with the crossbar being approximately 3.5 feet long (half on each side of the steel center bar). From the crossbar, a further extension on each side of the crossbar is formed where door hinge receiver and transport striker plate are located.

### EXAMPLE 2

### Detaching Vehicle Door(s) from Vehicle and Installing Detached Vehicle Door(s) into Vehicle Door Transport Device

With vehicle doors attached to the vehicle, the vehicle doors are opened using the door latch from outside of the vehicle. The detachable doors are then lifted off the vehicle mounted hinge receivers within the vehicle door frame. The detached doors are installed into vehicle door transport device transport receiver door hinge receivers and the door latch closed against striker plate.

### EXAMPLE 3

### Removing Vehicle Door(s) from Vehicle Door Transport Device and Installing Vehicle Door(s) into Vehicle Door Frame

The transported detached doors are re-installed onto the vehicle by opening the latch of the door while the doors are held within the vehicle door transport device. The door are opened away from the vehicle and the door is lifted up (out) of the hinge receivers of the vehicle door transport device. The doors hinges are placed back into vehicle mounted door hinge receivers and latch closed to secure the now attached vehicle doors into the vehicle door frame.

Although the vehicle door transport device 10 is applicable to detachable vehicle doors that having a latch mechanism for securing the door while it functions to hold or lock on a vehicle during use, it is particularly applicable for detachable doors from automotive vehicles of Jeep®, manufactured by AMC, Chrysler, Daimler-Chrysler under the models of Jeep CJ-5, CJ-6, CJ-7, Cj-8 and Wrangler, or Hummer®, manufactured by AM General, General Motors under the model of H-1.

The foregoing summary, description, and examples of the present invention are not intended to be limiting, but are only exemplary of the inventive features which are defined in the claims.

What is claimed is:

1. A vehicle door transport device for transporting removable vehicle doors, comprising:
one or more vehicle mountable door hinge transport receivers;
one or more vehicle securable door striker plates; and,
a positional support effective to fix the location of the door hinge and striker plates effective to receive and support one or more vehicle doors.

2. The vehicle door transport device of claim 1, wherein the positional support comprises a structural component of a vehicle.

3. The vehicle door transport device of claim 1, wherein the positional support comprises a bracket attachable to a vehicle.

4. The vehicle door transport device of claim 3, wherein the bracket is an attaching device selected from the group consisting of bolt mounted, slide mounted, snap mounted, twist mounted and combinations thereof.

5. The vehicle door transport device of claim 1, wherein the positional support attaches to a vehicle bumper, receiver hitch or spare tire mount.

6. The vehicle door transport device of claim 1, wherein the positional support comprises at least a first support piece for supporting the door hinge and striker plates.

7. The vehicle door transport device of claim 6, wherein the first support piece supports two or more vehicle doors.

8. The vehicle door transport device of claim 7, wherein the first support piece supports four vehicle doors.

9. The vehicle door transport device of claim 1, wherein supported vehicle doors are positioned in a layered configuration from the vehicle.

10. The vehicle door transport device of claim 1, wherein the vehicle door is a detachable door selected from the group consisting of Jeep® and Hummer®.

11. The vehicle door transport device of claim 1, wherein the location of one or both of the door hinge and striker plates are adjustable to each other.

12. A mounted vehicle door transport device comprising the vehicle door transport device of claim 1, wherein the vehicle door transport is mounted to the vehicle at a location selected from the group consisting of the vehicle's top, side, back, front and combinations thereof.

13. The mounted vehicle door transport device of claim 11, wherein the vehicle door transport is mounted to the back of a vehicle.

14. The mounted vehicle door transport device of claim 11, wherein the vehicle door transport is mounted to the side of a vehicle.

15. A method for transporting one or more vehicle doors, comprising the steps of:
providing on a vehicle a vehicle door transport device for transporting removable vehicle doors having one or more vehicle mountable door hinge transport receiver, one or more vehicle mountable door striker plates and a positional support effective to fix the location of the door hinge and striker plates effective to receive and support one or more vehicle doors;
mounting one or more vehicle doors into the vehicle door transport device by placing at least one door hinge into at least one door hinge transport receivers;
securing the door latch of the mounted vehicle door into the striker plate; and,
driving the vehicle.

16. The method of claim 15, further comprising the step of covering the mounted and secured vehicle doors.

17. The method of claim 15, wherein the transported vehicle doors originate from the transporting vehicle.

18. The method of claim 15, wherein the vehicle is a Jeep®.

19. The method of claim 15, wherein the vehicle is a Hummer®.

20. A transported vehicle door comprising the method of claim 15.
